(19) United States
(12) Patent Application Publication
(10) Pub. No.: US 2003/0140037 A1
(43) Pub. Date: Jul. 24, 2003

(54) Dynamic knowledge expert retrieval system

(76) Inventor: Kenneth Deh-Lee, Union city, CA (US)

Correspondence Address: HEWLETT-PACKARD COMPANY, Intellectual Property Administration, P.O. Box 272400, Fort Collins, CO, 80527-2400, US

(21) Appl. No.: 10/056,592

(22) Filed: Jan. 23, 2002

(51) Int. Cl. G06F 17/30

(52) U.S. Cl. 707/3

(57) ABSTRACT

The present invention relates to a system and method of generating a search result list of experts, substantially in real-time, in response to a search request from a user using a computer network. The system includes an updateable and searchable database of expert profiles, wherein attributes of each expert are stored within the profiles. The system receives search requests from users and applies a weight designated by the user to attributes of the expert as part of the search.

### BACKGROUND OF THE INVENTION

Presently, when an expert is needed, an individual either consults a handwritten or typed list that he has prepared and updated over the years or relies on associates to share their contacts. Either method of expert retrieval is outdated and limited in its information and reliability. Moreover, present search engines do not consider real-time dynamic attributes or provide adequate search parameters. The solution is a mobile web application that allows a user to access experts.

### BRIEF SUMMARY OF THE INVENTION

The present invention relates to a method of generating a search result list of experts substantially in real-time in response to a search request from a user using a computer network, involving maintaining an updateable and searchable database of expert profiles wherein attributes of an expert are stored within the profiles, receiving a search request from the user, and applying a weight designated by the user to attributes of the expert. The present invention provides an efficient method of finding relevant experts, thereby using the user's and expert's time more productively.

### BRIEF DESCRIPTION OF THE DRAWINGS

For a more complete understanding of the present invention, reference is now made to the

FIG. 1 is a block diagram showing the overall process used in one embodiment of the present invention; and

FIG. 2 is a flow diagram of one embodiment of the Expert Retrieval System of this invention.

### DETAILED DESCRIPTION OF THE INVENTION

The present invention pertains to a new Expert Retrieval System that allows a user to search a database that combines search technology, real-time availability and static profiles to provide an ordered list of relevant experts along with the expert's contact information.

The present invention relates to a method of generating a search result list, substantially in real-time, in response to a search request from a user. A computer network is used to maintain a database of experts. The user makes a search request that is sent to the database. Weights that are designated by the user are applied to various attributes of the desired expert, and a list of relevant experts is displayed. The displayed expert list may be ranked according to the user's parameters, a ranking algorithm or any other useful criteria.

In one embodiment, the list of experts may be ranked according to the search parameters that the user entered. Alternatively, the list may be ranked according to the user's individualized settings. Parameters, such as the expert's proximity to the user, the expert's current and/or future availability, a desired or available communication mode (such as electronic mail, telephone, messaging or mail), and the expert's area of expertise, may be used to rank the experts that are listed in a search result. Proximity between the user and the expert may be determined using Global Positioning Satellite (GPS), wireless telephone triangulation, or an address or other location identification. When the pool of potential experts comprises a list of experts from around the world, a region filter can also be implemented to rank the experts.

The database can be updated by the expert or by users that have permission. The users with permission are usually in management. Remote updating of the expert database is possible via the Internet using either a land line or wireless Internet connection.

The present invention allows an employee to access a support staff's collective knowledge whether the employee is at the office, at a customer's site or at another location. The Expert Retrieval System may be easily and effectively accessed by a mobile device such as a web enabled phone or a PDA (Personal Digital Assistant) with web access.

The present invention is also useful to users who do not require real-time access to an expert, but who still need to locate experts. For example, a customer accessing a support web site would also benefit from the Expert Retrieval System by locating an expert and retrieving the expert's contact information.

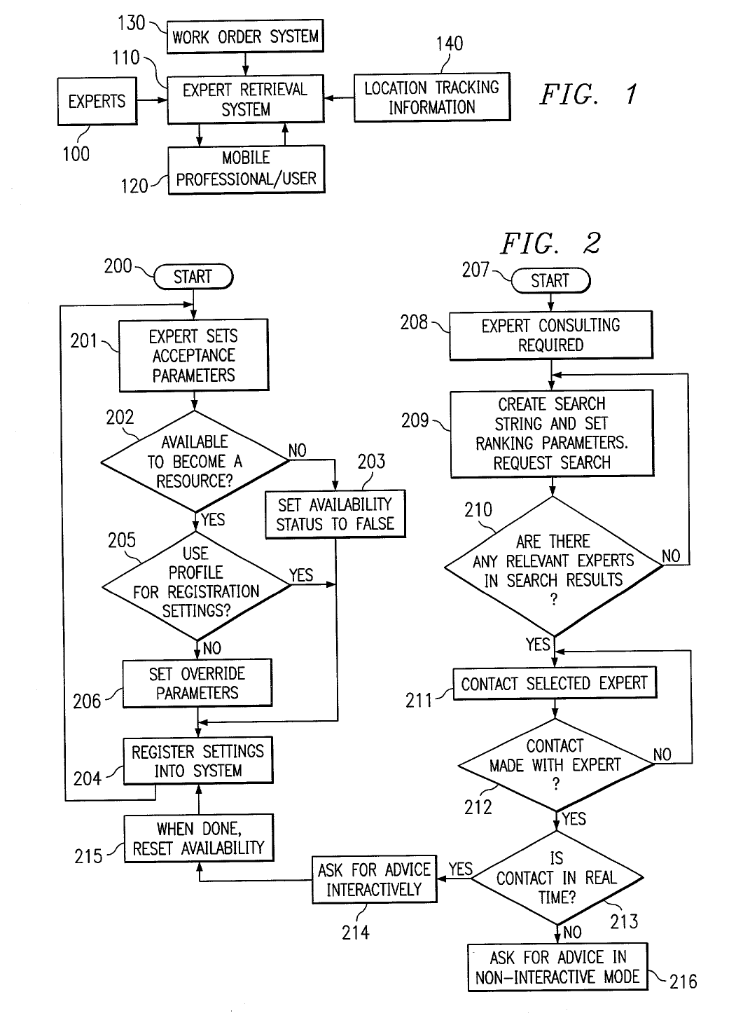

FIG. 1 is a block diagram of the database management side of the Expert Retrieval System. An individual expert or group of experts 100, or a user with permission, may go online to create an expert profile in the Expert Retrieval System 110. The expert or user 100 may use either a land line or wireless connection to access Expert Retrieval System 110. The expert profile includes data such as the expert's contact information as well as his or her area(s) of expertise. For example, areas of expertise may be marketing, sales, software support, hardware support, customer support, network maintenance and the like. More detailed information can also be entered, such as the expert's familiarity or specialization with certain hardware platforms, operating systems, tools product numbers and the like. In one embodiment, the areas of expertise may be selected from a predefined list of options. A free form text area can also be available for the expert or management to expand on the expert's knowledge base or to add alternate areas of expertise.

The expert or a user with permission may update the Expert Retrieval System by going on-line using either a land line or wireless connection. The Expert Retrieval System 110 can also be updated to reflect an expert's work assignments using data from work order system 130, or using location tracking information 140 and/or other information. A work assignment can be thought of as the expert's schedule for the day. Work order system 130 keeps track of estimated times of arrival and/or completion times for the experts. This data may then be used to determine whether the expert is available or busy at particular time.

A user, such as a mobile professional 120, can access Expert Retrieval System 110 via a mobile or wireless device, such as a web enabled phone or a PDA with web access. This allows user 120 to perform expert searches from virtually any location.

FIG. 2 is a flowchart that illustrates the operation of one embodiment of Expert Retrieval System 110. FIG. 2 also illustrates how experts update their availability status in Expert Retrieval System 110.

Beginning at step 200, Expert Retrieval System 110 allows an expert to access his or her profile and to update availability information or other data within the profile. The expert sets acceptance parameters in step 201. The acceptance parameters relate to information such as the expert's area of expertise and the expert's availability to consult. In step 202, Expert Retrieval System 110 determines if the expert is available to become a resource or to consult. If the expert is unavailable, his availability status is set to false in step 203, and the availability settings are registered in Expert Retrieval System 110 in step 204.

When the expert is available to become a resource or to consult, the acceptance parameters entered in step 201 are compared to the expert's current profile in step 205. If the expert's acceptance parameters are different than those in his or her profile, the expert can override parameters in step 206 to reflect the new acceptance parameters. If the expert does not set override parameters in step 206, the expert's saved profile keeps the original or default settings. If the expert is unavailable for consulting in step 202, the expert or a user with permission can indicate the time estimated until the expert will become available for another assignment.

In the situation where an expert is engaged in a non-interactive consulting session, the expert or a manager can request that Expert Retrieval System 110 change the expert's status to unavailable using the above-described process. When the expert is engaged in non-interactive consulting, the expert can refrain from setting his or her status to unavailable and may, instead, elect to stay available and to continue receiving consulting requests. In one embodiment, each request can be queued and answered in order. In an alternative embodiment, if a general purpose messaging tool or email is used, queuing may not be used in the expert retrieval system. Once the expert contact is facilitated, the expert is not considered for assignment by the expert retrieval system until the expert resets his or her availability status to available.

Referring back to FIG. 1, when user 120 needs to consult an expert, the user may access Expert Retrieval System 110 through the Internet. The user then enters a search request by selecting desired expert attributes and other searching parameters. The search parameters include the expert needed, the product that is the subject of the consultation, issue categories such as errors, diagnostics, configuration, installation, and the like. Expert Retrieval System 110 may also have a user's profile stored on a server to allow the user to configure and recall his own personal expert search preferences. For example, the user's personal preferences list may be a list of certain experts that the user has worked with in the past or it may be a modification to a default ranking algorithm.

Weights are assigned by the user to certain searching parameters so that certain expert attributes are more important than others. The user can also assign weights to individual experts so that particular experts might be selected more or less frequently. The ranking algorithm operates on the weights the user assigned to the parameters and/or attributes of the expert to create a score for each expert in the results list. The ranking algorithm may take into account any number of search parameters. The search parameters may be predefined or each user may set his or her own search parameters.

In a preferred embodiment, the expert search itself is a keyword lookup and mathematical calculation for a score that is, in the end, sorted to form an expert list. The expert search algorithm will rely on standard keyword searching algorithms. In traditional ranked searches, the list is ordered so that response items that contain the most number of search parameters are listed first. Accordingly, those response items with all or most of the keywords have a higher rank, and those response items with missing or fewer keywords have a lower rank.

For example, if the search sought an expert on product ABC, who was available to use communication type “phone call,” and who had an expertise in a certain operating system, then the keyword search can be an “ORed” search instead of an “ANDed” search. However, the expert who applies to all criteria will be given a higher score. A benefit of this search is that the results list will include response items that did not contain some of the search criteria since the search is relaxed. This is beneficial when a more complex search is performed and no response items match completely, for example, a search having many keywords. A combination of ranking and filtering on the list can be an alternative algorithm.

FIG. 2 also shows a flow diagram of the various user and expert interfaces to Expert Retrieval System 110. Beginning at step 207, a user may search for an expert. A user determines expert consulting is required in step 208. In step 209, a search string is created 220. The search string can be created by entering keywords or selecting options within one or more of the searching parameter selections. After the user has entered all necessary data, Expert Retrieval System 110 will run the search and return an ordered list of experts ranked using static and dynamic information.

The dynamic information may include, for example, the proximity of the expert to the user. This may be calculated using Global Positioning System (GPS) software that would define the user's location in relation to the expert's location or a fixed location. Location may also be determined by comparing the expert's and the user's working address. Other dynamic information, such as the amount of time the expert has left until his next assignment or the expert's current availability status, may be used to rank experts.

In step 210, the user can evaluate the search results and determine if there are any relevant experts listed. If no expert fits the user's requirements, the user may return to step 209 to revise the search parameters. On the other hand, if one or more relevant experts are listed, then the user selects an expert and contacts the expert in step 211.

In one embodiment, the user may contact the selected expert by clicking on the expert's name as displayed in the results list. After the expert's name is clicked, a pop-up menu may be displayed showing different contact methods, such as email, telephone, mail, or on-line messaging. If the user wants to consult by email, “email” is selected and an email interface appears enabling the user to send an email message to the expert. If the user want to consult by telephone, “telephone” is selected and the expert's telephone contact information is displayed.

Certain methods of contacting the experts, such as electronic mail contacts, are non-interactive, and the expert's availability status is not updated automatically following the contact. If the user wants to consult in real-time, for example by telephone or on-line messaging, he or she selects “telephone” or “on-line” options from the expert's contact information. In step 212, Expert Retrieval System 110 determines if contact has been made with the expert, and in step 213, Expert Retrieval System 110 determines if the contact is in real-time.

In step 214, the user requests interactive or real-time advice. If the expert engages in on-line (i.e. real-time) consulting with the user, then the expert's current status must be updated. The expert's status can change to either “unavailable” or “available but consulting online” while the expert is on the telephone with a user or otherwise consulting with the user. The change in the expert's status may be accomplished by setting the expert's availability flag to false in step 203. As a result, the non-availability settings will be updated to Expert Retrieval System 110 in step 204. When the on-line or real-time consulting is terminated, Expert Retrieval System 110 resets the expert's status to “available” in step 215 and the updated settings are registered in the database.

In a preferred embodiment, an expert may configure that his or her status be set to “unavailable” for all forms of consulting if the expert does not want consulting requests to become queued. One of skill in the art will understand that it will be easier to set the expert's status from available to unavailable because the initiation of contact with a user can be assumed to set the expert's status to unavailable. The system may be configured to make certain assumptions, such as assuming that when an initiated communication method (e.g. telephone contact) is terminated, then the consulting is completed.

When an on-line message is sent to the expert, but the expert does not immediately engage in on-line consulting, a message may be left with the expert. This type of communication is non-interactive. Thus, the Expert Retrieval System does not update the expert's status to unavailable because there is no real-time communication. Instead, in step 216, the user requests that the user provide advice in a non-interactive mode.

When an expert is “unavailable” or “available but consulting” his rank in further search requests will be affected because he is no longer “available” at the time of the new search.

An advantage over a standard search engine is that the result of a search pursuant to the present invention is a list of experts ranked or prioritized based on proximity, availability, area of expertise, and/or a set of the user's personal preferences. The ranking algorithm is based on static attributes such as knowledge area and local region and dynamic attributes such as proximity, availability and the user's personal preferences. Exemplary attributes are as follows:

Availability: Expert Retrieval System 110 may show that the expert is unavailable, available or consulting (i.e. available but currently consulting online).

Time to Next Appointment: A time can be entered manually by the expert or by management indicating the amount of time the expert has until a next-scheduled assignment. Alternatively, Expert Retrieval System 110 may estimate the amount of time an expert has until a next appointment based on the location of the next assignment in relation to the expert's current location using, for example, GPS information and travel speed. One skilled in the art would understand how to use GPS information to calculate the travel speed.

Area of Expertise: Expert Retrieval System 110 may use a standard predefined list of options that cover each applicable area of expertise. This list can be updateable by users with permission, such as a manager, or by the expert himself. Also, Expert Retrieval System 110 itself can be programmed to automatically update certain parameters, for example, setting the expert's availability to “unavailable” when the expert's next assignment date begins.

Proximity: Expert Retrieval System 110 may store the expert's location. The system may use fixed locations, such as a general area or region, or moving coordinates, such as GPS coordinates. If GPS information is used, the coordinates may come from the expert's mobile or wireless device, such as a PDA or telephone.

Personal Preferences: Expert Retrieval System 110 may store a list of resources or factors that are deemed more important by the user. These resources or factors may also be weighted to reflect their importance to the user.

While certain exemplary embodiments have been described in detail it is to be understood that such embodiments are merely illustrative of and not restrictive on the broad invention, and that this invention is not to be limited to the specific arrangements and constructions shown and described, since various other modifications may occur to those with ordinary skill in the art.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the methods and steps described in the specification. As one of ordinary skill in the art will readily appreciate from the disclosure of the present invention, methods, or steps, presently existing or later to be developed that perform substantially the same function or achieve substantially the same result as the corresponding embodiments described herein may be utilized according to the present invention. Accordingly, the appended claims are intended to include within their scope such methods, or steps.

What is claimed is:

1. A method of identifying relevant experts substantially in real-time using a search request from a user, comprising:
maintaining an updateable and searchable database of expert profiles, wherein the profiles include attributes of a particular expert;
receiving a search request from the user; and
applying a weight designated by the user to the attributes of a desired expert.

2. The method of claim 1 further comprising:
searching the database using the search request; and
displaying a list of ranked experts, wherein each expert's position in the ranked list is determined by a ranking algorithm that uses the weights of each attribute.

3. The method of claim 1 wherein the attribute is the expert's availability.

4. The method of claim 3 wherein the database automatically updates the expert's availability.

5. The method of claim 1 wherein the attribute is the expert's area of knowledge.

6. The method of claim 1 wherein the attribute is the expert's available time until a next assignment.

7. The method of claim 1 wherein the attribute is the expert's proximity to the user.

8. The method of claim 1 wherein the attribute is the expert's available contact method.

9. The method of claim 1 wherein the attribute is the expert's travel speed.

10. The method of claim 2 wherein the user is automatically connected to a selected expert by interfacing with the expert's name as it appears on the displayed list.

11. The method of claim 2 wherein a menu appears with available contact mediums when an expert is selected.

12. The method of claim 11 wherein the contact medium is email and when selected a dialog box appears for the user to prepare and send an email to the expert.

13. The method of claim 1 1 wherein the contact medium is telephone and when selected the expert's telephone number is displayed.

14. The method of claim 1 further comprising:
selecting a messaging communication mode by which the user contacts a selected expert.

15. The method of claim 1 wherein the profile is able to be created by the expert.

16. The method of claim 1 wherein the profile is able to be updated by the expert.

17. A system for searching for experts having particular attributes, comprising:
a searchable and updateable database of expert information, wherein said database comprises a plurality of expert profiles, each of said profiles including data relating to one or more attributes of a particular expert; and
a user interface for allowing users to identify desired characteristics of a desired expert, wherein the user interface also allows users to assign weights to one or more of the desired characteristics.

18. The system of claim 17 further comprising a processor for comparing a user's desired expert characteristics to the attributes stored in each of said expert profiles.

19. The system of claim 18 further comprising a display for displaying to the user a list of experts that fit one or more of the user's desired characteristics.

20. The system of claim 19 wherein the list of experts is ranked according to a correlation between each expert's expert profile and the user's desired expert characteristics, wherein the list is further ranked according to weights that the user has assigned to certain characteristics.

21. The system of claim 17 wherein a user interfaces with the database via a remote wireless or wireline Internet connection.
